(19) United States
(12) Patent Application Publication
(10) Pub. No.: US 2012/0019649 A1
(43) Pub. Date: Jan. 26, 2012

(54) Measurement of Textile Fabrics

(76) Inventors: Christopher Nixon, Nottingham (GB); Andrew Thorne, Nottingham (GB)

(21) Appl. No.: 13/257,734

(22) PCT Filed: Mar. 11, 2010
(86) PCT No.: PCT/GB2010/000442

§ 371 Date: Sep. 20, 2011

(30) Foreign Application Priority Data
Mar. 20, 2009 (GB) 0904833.1

(51) Int. Cl. G06K 9/00; H04N 7/18

(52) U.S. Cl. 348/86; 382/111; 348/E07.085

(57) ABSTRACT

Apparatus for the measurement of textile fabrics comprising at least one sensor having an associated sensor field. A feed arrangement presents an area of a textile fabric length at the sensor field. The feed arrangement also provides relative movement between the sensor and the textile fabric length to present a sequence of areas of fabric at the sensor field. The sensor is repeatedly operated to provide a colour output representing fabric colour and measured from respective areas of the fabric, as sequentially presented at the sensor field. The feed arrangement operates, each time the sensor provides a colour output, to provide a respective position output representing the position of the sensor relative to the fabric. The feed arrangement and sensor provide a sequence of colour outputs measured from known areas of the fabric, represented by the respective position outputs.

The present invention relates to measurement of textile fabrics. In particular, the invention relates to measurement of fabric colour, shade or the like.

Example embodiments of the present invention provide apparatus comprising:
a sensor having an associated sensor field;
a feed arrangement operable to present an area of a textile fabric length at the sensor field;
the feed arrangement being further operable to provide relative movement between the sensor and the textile fabric length to present a sequence of areas of fabric at the sensor field;
the sensor being repeatedly operable to provide a colour output representing fabric colour and measured from respective areas of the fabric sequentially presented at the sensor field;
and the feed arrangement being operable, each time the sensor provides a colour output, to provide a respective position output representing the position of the sensor relative to the fabric,
the feed arrangement and sensor thereby providing a sequence of colour outputs measured from known areas of the fabric represented by the respective position outputs.

In this specification, the term “colour” is used to refer to hue, shade, reflectivity or any other parameter of visual appearance which is visible to the eye.

The feed arrangement may be operable to provide relative movement by moving the textile fabric length. The feed arrangement may be operable to unroll the textile fabric length from a roll and to present an unrolled area at the sensor field. The textile fabric length may be unrolled from a first roll and rolled to a second roll, the fabric being presented at the sensor field while unrolled between the first roll and the second roll. The sequence of areas presented at the sensor field may form a line of positions along the textile fabric length.

There may be a plurality of sensors as aforesaid, each having a respective associated sensor field. The plurality of sensors may be arrayed to measure from respective lines of fabric areas, as the textile fabric length moves relative to the sensors. The sensor fields of the plurality of sensors may be arrayed substantially perpendicular to the direction of relative movement of the textile fabric length and the sensors.

The apparatus may further comprise memory means operable to store the colour outputs and respective position outputs. The colour outputs and respective position outputs may be collated to form a dataset representing a map of the textile fabric length. The apparatus may further comprise a visual display means, the visual display means being operable to provide a visual representation of the map.

The sensor may provide colour outputs in RGB format. The apparatus may further comprise control means operable to analyse the colour outputs. The control means may be operable to analyse the colour outputs from each fabric length to assign an overall colour measurement for each fabric length. The control means may be operable to determine the range of colours represented by the colour outputs for a fabric length. The control means may be operable to determine if the range of colours is greater than a permitted maximum range. The control means may be operable to compare colour outputs to identify matching areas of the fabric by reference to the position outputs. The control means may be operable to analyse the colour outputs in order to calculate Delta E values.

Examples of the invention also provide a method comprising:
receiving a sequence of colour outputs representing the fabric colour of a sequence of areas of a textile fabric length;
receiving a respective position output for each of the colour outputs;
and determining the position of each of the sequence of areas on the textile fabric length;
thereby providing a sequence of colour outputs measured from known areas of the fabric represented by the respective position outputs.

A feed arrangement may be used to provide relative movement between a sensor and the textile fabric length to present a sequence of areas of fabric at the sensor.

Relative movement may be provided by moving the textile fabric length. The textile fabric length may be unrolled from a roll, an unrolled area being presented at the sensor. The textile fabric length may be unrolled from a first roll and rolled to a second roll, the fabric being presented at the sensor while unrolled between the first roll and the second roll. The sequence of areas presented at the sensor may form a line of positions along the textile fabric length.

There may be a plurality of sensors. The plurality of sensors may be arrayed to measure from respective lines of fabric areas, as the textile fabric length moves relative to the sensors. The sensor fields of the plurality of sensors may be arrayed substantially perpendicular to the direction of relative movement of the textile fabric length and the sensors.

The colour outputs and respective position outputs may be stored. The colour outputs and respective position outputs may be collated to form a dataset representing a map of the textile fabric length. A visual display means may be used to provide a visual representation of the map.

The colour outputs may be analysed. The colour outputs from each fabric length are analysed to assign an overall colour measurement for each fabric length. The colour outputs may be analysed to determine the range of colours represented by the colour outputs for a fabric length. The method may determine if the range of colours is greater than a permitted maximum range. The method may compare colour outputs to identify matching areas of the fabric by reference to the position outputs. The method may analyse the colour outputs in order to calculate Delta E values.

The invention also provides software which, when installed on a computer system, is operable to perform the whole or any part of the preceding method. The invention also provides a computer readable medium having machine-readable instructions recorded thereon and representing software as aforesaid.

In another aspect, examples of the invention provide a batch of fabric panels cut from fabric lengths, the fabric panels being matched in accordance with colour outputs and position outputs obtained by means of the apparatus set out above, or in accordance with the method set out above.

Examples of the present invention will now be described in more detail, by way of example only, and with reference to the accompanying drawings, in which:

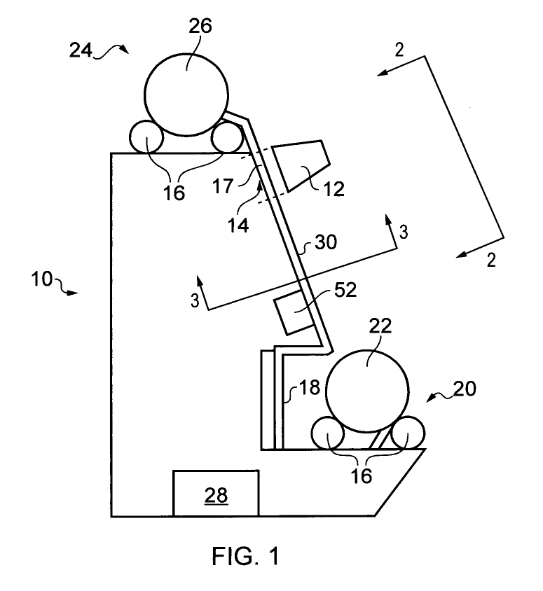

FIG. 1 is a schematic side view of an example apparatus for use in implementing the invention;

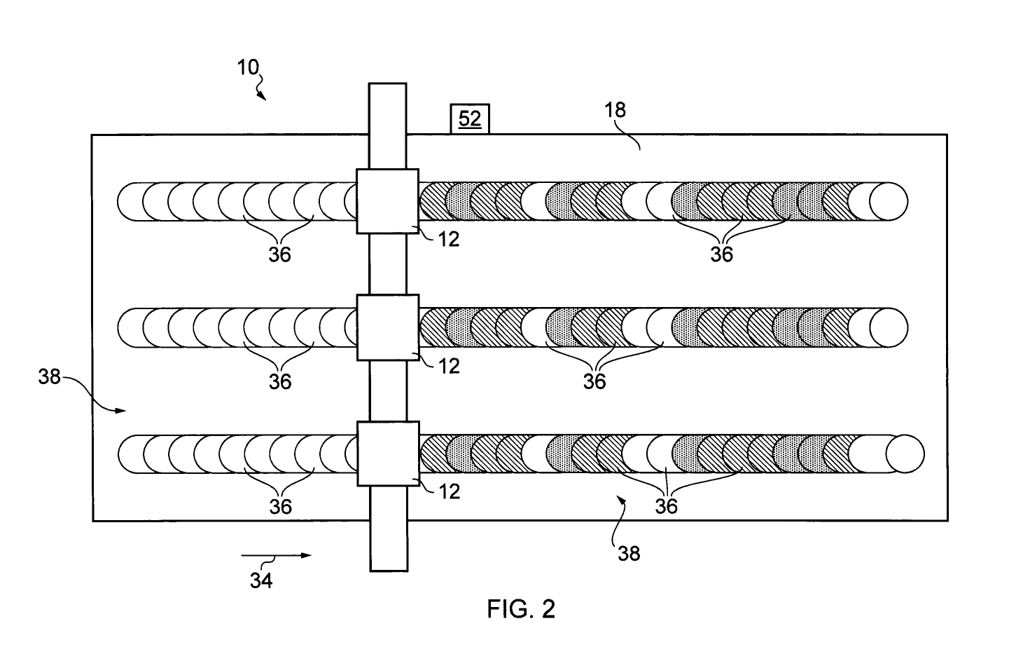

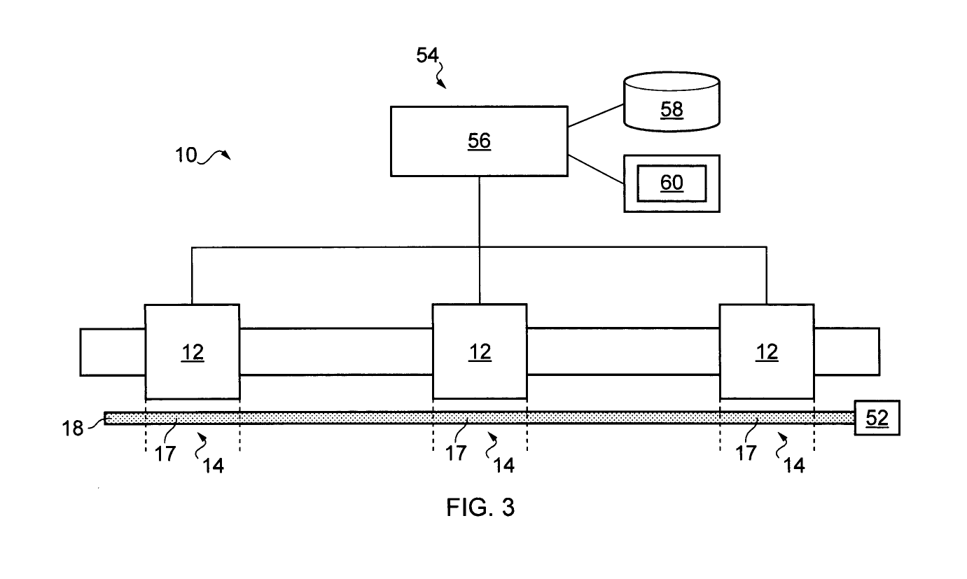

FIGS. 2 and 3 are schematic views of the apparatus of FIG. 1; at the lines 2-2 and 3-3 in FIG. 1;

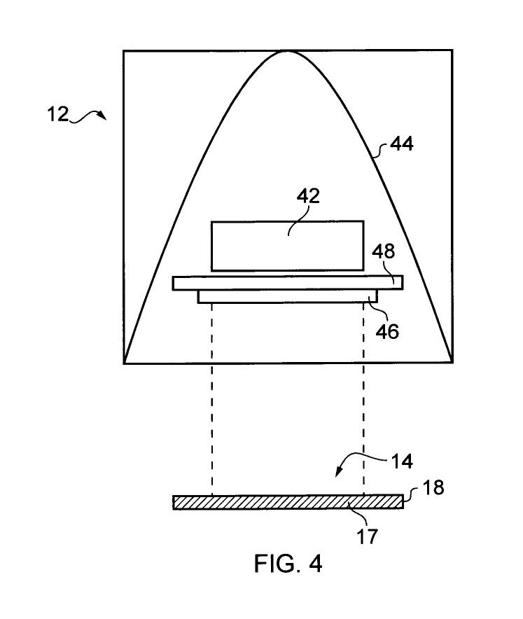

FIG. 4 is an enlarged schematic view of a sensor;

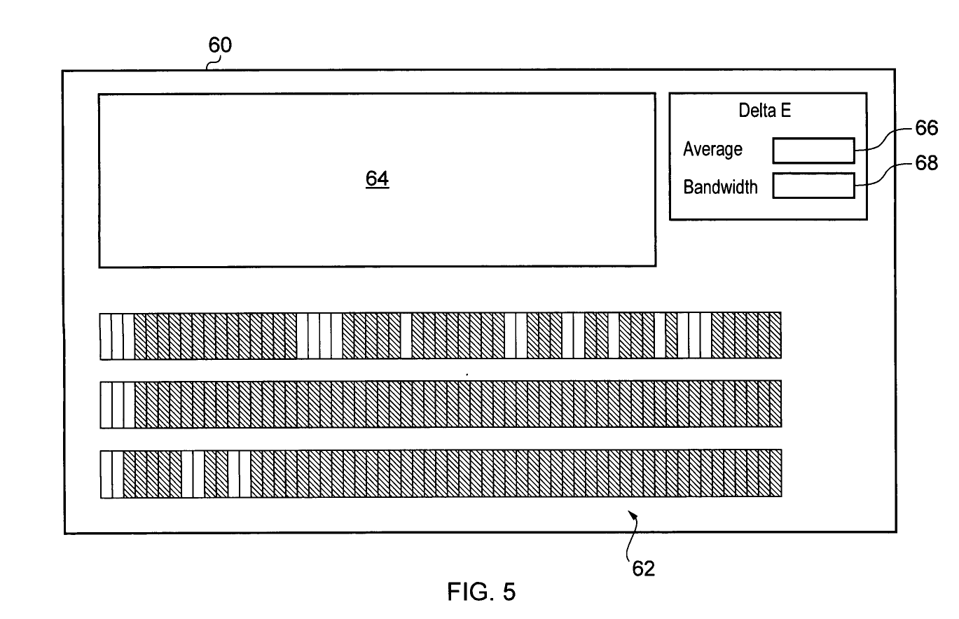

FIG. 5 illustrates a display of the device; and

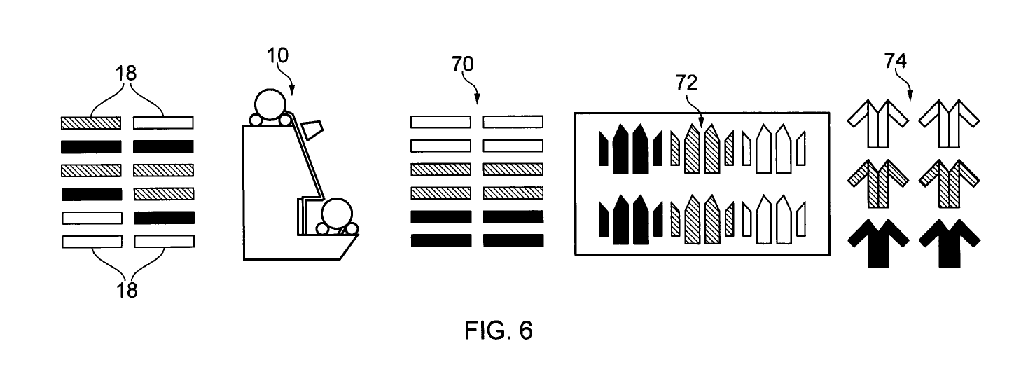

FIG. 6 illustrates an example method of the invention.

The drawings illustrate apparatus 10 comprising at least one sensor 12 having an associated sensor field indicated generally at 14. A feed arrangement 16 is operable to present an area 17 of a textile fabric length 18 at the sensor field 14. The feed arrangement 16 also provides relative movement between the sensor 12 and the textile fabric length 18 to present a sequence of areas 17 of fabric at the sensor field 14. The sensor 12 is repeatedly operated, as will be described, to provide a colour output representing fabric colour and measured from respective areas 17 of the fabric, as sequentially presented at the sensor field 14. The feed arrangement 16 operates, each time the sensor 12 provides a colour output, to provide a respective position output representing the position of the sensor 12 relative to the fabric 18. The feed arrangement 16 and sensor 12 thereby providing a sequence of colour outputs measured from known areas 17 of the fabric 18, represented by the respective position outputs.

In more detail, the apparatus 10 has an unrolling station 20 for receiving a roll 22 of textile fabric. A rolling station 24 is provided for receiving an initially empty roll 26. The apparatus 10 has a drive mechanism illustrated schematically at 28 and defines a path 30 for a web of fabric 18 to pass from the roll 22, along the path 30, to the empty roll 26. Accordingly, the feed arrangement 16, including the drive mechanism 28, provides relative movement between the textile fabric length 18 and the sensor 12, by moving the textile fabric length 18. Alternatively, the sensor 12 could be moved to scan the surface of the length 18, but the extreme length of fabric rolls used commercially (which may be up to 5 km in length) makes it more practical to move the fabric past the sensor 12. A combination of movement of the sensor 12 and the fabric length 18 could be used. As the textile fabric length moves along the path 30 from the roll 22 to the roll 26, a line of positions along the textile fabric length 18 will be sequentially presented to the sensor 12.

FIGS. 2 and 3 illustrate the textile fabric length 18 as it moves along the path 30 of the apparatus 10. The fabric length 18 moves past the sensor 12 which, in this example, includes three sensor heads 12. A different number of sensor heads 12 could be used. It is envisaged that as many as thirty sensor heads 12 could be used together. Each sensor head 12 has a respective sensor field 14 associated with it, as will be described. The sensor heads 12 are arrayed, in this example, in a line which is generally perpendicular with the direction of movement of the textile fabric length 18 relative to the sensor heads 12, this direction being indicated in FIG. 2 by an arrow 34. As the fabric length 18 moves past the sensor heads 12, a line of positions 36 passes each sensor head 12. The positions 36 are diagrammatically illustrated in FIG. 2 as overlapping circular regions. In the region 38, before the fabric 18 reaches the sensor heads 12, each position 36 is plain, for reasons which will become apparent. In the region 40, after the fabric 18 has passed the sensor head 12, each position 36 is shaded, for reasons which will become apparent.

It can be seen from FIG. 2 that the sensor heads 12 define respective lines of positions 36 which run parallel along the length of the fabric length 18. As the textile fabric length 18 is fully unrolled from the roll 22 to the empty roll 26, the lines of positions 36 will extend along the whole length of the fabric length 18.

One of the sensor heads 12 is illustrated in more detail in FIG. 4. The sensor head 12 includes a transducer 42 housed within a shroud 44 to reduce the effects of ambient light, reflections etc. A light source 46 is provided to create reliable, consistent lighting in the vicinity of the head 12. Control electronics 48 or other apparatus associated with the head 12 may also be housed within the shroud 44, which may act as a reflector to cast the output of the light source 46 onto the textile fabric length 18. The transducer 42 has a viewing angle 50, illustrated by broken lines in FIG. 4, which therefore defines a sensor field 14 at the fabric length 18. As the textile fabric length 18 moves past the sensor head 12, a sequence of areas of fabric will be presented to the sensor head 12.

The transducer 42 of each sensor head 12 is able to take a measurement from the corresponding sensor field 14, representing the fabric colour seen by the transducer 42 at the field 14. Suitable transducers for measuring colour are known in themselves and may report in a number of standard formats. One format is known as RGB format, and is used in this example. RGB format allows other formats to be calculated from it, if required or desired.

The fabric colour is therefore measured without damaging the fabric.

The apparatus 10 also includes a position encoder 52 which detects the movement of the textile fabric length 18 along the path 30. Accordingly, the encoder 52 can report the length of fabric which has passed. This position, together with the relative positions of the encoder 52 and the sensor heads 12 allows the determination of the current position of each of the sensor fields 14 on the textile fabric length 18. That is, each time a sensor head 12 provides a colour output representing fabric colour, measured from the respective sensor field 14, a position output can be taken from the position encoder 52. This links the colour output to a particular position on the fabric length 18, as has just been explained.

It is for this reason that the regions 38, prior to the sensor 12, are plain, because no information is yet known about fabric colour in the region 38. However, the regions 40 have passed the sensor 12, colour outputs have been obtained from the sensor heads 12 and position outputs have been obtained from the position encoder 52, so that the colour of the regions 40, and their position, are both now known and are therefore illustrated in FIG. 2 by the simple diagrammatic schema of dark areas, light areas and shaded areas, to indicate three different colours. It should be understood that in a practical example, using conventional colour measurement techniques, many more than three discrete colour states would be identified.

The colour outputs from the sensor heads 12, and the position outputs from the position encoder 52 are all fed to a control arrangement 54 which may, for example, be implemented by means of appropriate software running on a general purpose computer. For the purpose of understanding the present invention, it is sufficient to explain that the control arrangement 54 includes a data processing element 56, associated memory 58 and a visual display unit 60. In this example, all colour outputs and respective position outputs received from the sensor heads 12 and position encoder 52 are stored in the memory 58 of the data-processing element 56. Further data-processing can then take place. In particular, the correspondence between each colour output and its respective position output allows the data to be collated to form a dataset which represents a map of the colour of the textile fabric length 18. This map, as it is being formed, is indicated in FIG. 2 by the appearance of the regions 40.

The map may be presented to the user by means of the visual display unit 60, under control from the data-processing element 56. FIG. 5 illustrates an example of a display. The lower region 62 shows a map collated from the colour outputs and respective position outputs. The map may show the detected colours, or be in any other appropriate format to provide the required information to the user. For example, the data-processing element 56 may analyse the colour outputs and present the results of the analysis in the region 62, rather than presenting the actual colours detected. The analysis may determine any areas whose colour varies from a target colour by more than a maximum allowable amount. Variation may be measured by a conventional colour measurement technique. In this example, variation is calculated as a Delta E value calculated by the data-processing element 56 from RGB outputs from the sensor heads 12. Delta E values measure the variance of a colour or shade from the intended value. A Delta E value greater than unity indicates a difference which is visible to the human eye. A Delta E value less than unity indicates a difference which is not visible to the human eye.

Alternatively, the analysis may compare colour outputs from various different areas across the fabric length 18 in other ways, to identify those areas which provide an acceptably close visual match (for garment manufacture, for example).

Accordingly, the map shown in the region 62 may indicate areas which match or which lie outside the permitted colour range for the particular roll, rather than showing the actual colour detected.

Additional information can be provided in the upper region 64 of the display 60, such as information identifying the roll of fabric, its manufacturer, intended colour etc. Other fields may include an average Delta E value 66 for the whole of the textile fabric length 18, and an indication 68 of bandwidth (variation) of Delta E values across the length 18.

Analysis of the colour outputs and position outputs may be executed locally, at the apparatus 10, or remotely. In the case of remote analysis, this may take place within the same premises, or the data may be transmitted by any appropriate medium, including the Internet, for analysis elsewhere.

FIG. 6 schematically represents a complete process for manufacturing items of clothing from textile fabric, to provide an example of the manner in which examples of the present invention may be used.

In FIG. 6, a batch of textile fabric lengths 18 have been received from a manufacturer. These are all intended to have a particular intended colour, but in practice, there will be colour variations between lengths, and within a single length. The lengths 18 are schematically illustrated as bars of block shading or line shading, or unshaded to indicate different colours. Again, only three alternatives are shown, solely for illustrative purposes. In a practical example, the fabric lengths 18 will usually be rolls of fabric.

Each of the textile fabric lengths 18 is first inspected by passing the roll through the apparatus 10, described above. In this first example, this allows a Delta E value to be measured for each length 18, representing the average variance of the colour of that length from the intended colour for the roll. Accordingly, the lengths 18 can be sorted (indicated at 70) to group them into matching colour groups. That is, the average variance of two rolls may indicate that the fabric of those two rolls will match tolerably for garment manufacture, even though those rolls will not acceptably match with other rolls of the batch. The rolls are allocated to groups on this basis. Each length 18 can then be cut into panels 72 from which garments can be made. The resulting panels 72 indicated in FIG. 6 are kept in groups corresponding with the groups of rolls from which they were cut and thus, they remain grouped according to their colour. This grouping readily allows garments 74 to be constructed from groups of matching panels 72, so that the resulting garments 74 will pass quality control checks in relation to colour match, even though there will be variation between garments made from different groups. Thus, it is expected that by grouping panels 72 only from lengths 18 which match each other, to create groups of panels 72 which match each other, the risk of creating a single garment 74 from several panels 72 which do not match each other can be significantly reduced, so that the rejection rate of finished garments 74 can also be significantly reduced.

In the example just described, many colour measurements made across and along each roll are used to assign an overall colour measurement to that roll. It is the overall measurement which then determines the grouping of rolls, and hence the grouping of garment panels.

In a further example, the apparatus 10 is used to form a map of each length 18, and the lengths 18 are then cut into panels 72 with due regard to the colours indicated by the maps. Thus, a length 18 which has colour variation within it, can be used to contribute panels 72 to different groups. That is, panels cut from within the single length 18 are grouped with other panels of the same colour variation cut from the same length 18 or from another length 18. Again, it is envisaged that by grouping panels 72 according to their colour, and facilitating this grouping by forming the map by operation of the apparatus 10, there will be a significantly reduced risk of garments 74 being formed from panels 72 which do not match each other.

In this second example panels are grouped according to the colour of the panel itself, regardless of colour variation elsewhere on the same roll.

We envisage that in many practical situations, it will be possible to produce garments of adequate quality even if some of the lengths 18 do not match each other, or do not have consistent colour along their length. This will result in garments 74 which vary in colour from garment to garment, but which have acceptable panel matching within each garment. However, in the event that any length 18 is found to be unacceptably variant from the intended colour, as detected by the apparatus 10, the whole length 18 or the detected part of the length 18 can be rejected.

Wastage arising from rejection of finished garments is therefore expected to be significantly reduced.

Many variations and modifications may be made to the apparatus described above, without departing from the scope of the present invention. For example, many technologies and techniques could be used for the sensors and for processing, using and displaying the data.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus comprising:
a sensor having an associated sensor field;
a feed arrangement operable to present an area of a textile fabric length at the sensor field;
the feed arrangement being further operable to provide relative movement between the sensor and the textile fabric length to present a sequence of areas of fabric at the sensor field;
the sensor being repeatedly operable to provide a colour output representing fabric colour and measured from respective areas of the fabric sequentially presented at the sensor field;
and the feed arrangement being operable, each time the sensor provides a colour output, to provide a respective position output representing the position of the sensor relative to the fabric,
the feed arrangement and sensor thereby providing a sequence of colour outputs measured from known areas of the fabric represented by the respective position outputs.

2. Apparatus according to claim 1, wherein the feed arrangement is operable to provide relative movement by moving the textile fabric length.

3. Apparatus according to claim 1, wherein the feed arrangement is operable to unroll the textile fabric length from a roll and to present an unrolled area at the sensor field.

4. Apparatus according to claim 1, wherein the textile fabric length is unrolled from a first roll and rolled to a second roll, the fabric being presented at the sensor field while unrolled between the first roll and the second roll.

5. Apparatus according to claim 1, wherein the sequence of areas presented at the sensor field form a line of positions along the textile fabric length.

6. Apparatus according to claim 1, wherein there is a plurality of sensors as aforesaid, each having a respective associated sensor field.

7. Apparatus according to claim 6, wherein the plurality of sensors is arrayed to measure from respective lines of fabric areas, as the textile fabric length moves relative to the sensors.

8. Apparatus according to claim 6, wherein the sensor fields of the plurality of sensors is arrayed substantially perpendicular to the direction of relative movement of the textile fabric length and the sensors.

9. Apparatus according to claim 1, wherein the apparatus further comprises memory means operable to store the colour outputs and respective position outputs.

10. Apparatus according to claim 1, wherein the colour outputs and respective position outputs are collated to form a dataset representing a map of the textile fabric length.

11. Apparatus according to claim 10, wherein the apparatus further comprises a visual display means, the visual display means being operable to provide a visual representation of the map.

12. Apparatus according to claim 1, wherein the sensor provides colour outputs in RGB format.

13. Apparatus according to claim 1, wherein the apparatus further comprises control means operable to analyse the colour outputs.

14. Apparatus according to claim 13, wherein the control means is operable to analyse the colour outputs from each fabric length to assign an overall colour measurement for each fabric length.

15. Apparatus according to claim 13, wherein the control means is operable to determine the range of colours represented by the colour outputs for a fabric length.

16. Apparatus according to claim 15, wherein the control means is operable to determine if the range of colours is greater than a permitted maximum range.

17. Apparatus according to claim 13, wherein the control means is operable to compare colour outputs to identify matching areas of the fabric by reference to the position outputs.

18. Apparatus according to claim 13, wherein the control means is operable to analyse the colour outputs in order to calculate Delta E values.

19. (canceled)

20. A method comprising:
receiving a sequence of colour outputs representing the fabric colour of a sequence of areas of a textile fabric length;
receiving a respective position output for each of the colour outputs;
and determining the position of each of the sequence of areas on the textile fabric length;
thereby providing a sequence of colour outputs measured from known areas of the fabric represented by the respective position outputs.

21. A method according to claim 20, wherein a feed arrangement is used to provide relative movement between a sensor and the textile fabric length to present a sequence of areas of fabric at the sensor.

22. A method according to claim 21, wherein relative movement is provided by moving the textile fabric length.

23. A method according to claim 21, wherein the textile fabric length is unrolled from a roll, an unrolled area being presented at the sensor.

24. A method according to claim 21, wherein the textile fabric length is unrolled from a first roll and rolled to a second roll, the fabric being presented at the sensor while unrolled between the first roll and the second roll.

25. A method according to claim 21, wherein the sequence of areas presented at the sensor forms a line of positions along the textile fabric length.

26. A method according to claim 21, wherein there is a plurality of sensors.

27. A method according to claim 26, wherein the plurality of sensors is arrayed to measure from respective lines of fabric areas, as the textile fabric length moves relative to the sensors.

28. A method according to claim 26, wherein the sensor fields of the plurality of sensors are arrayed substantially perpendicular to the direction of relative movement of the textile fabric length and the sensors.

29. A method according to claim 20, wherein the colour outputs and respective position outputs are stored.

30. A method according to claim 20, wherein the colour outputs and respective position outputs are collated to form a dataset representing a map of the textile fabric length.

31. A method according to claim 30, wherein a visual display means is used to provide a visual representation of the map.

32. A method according to claim 20, wherein the colour outputs are analysed.

33. A method according to claim 20, wherein the colour outputs from each fabric length are analysed to assign an overall colour measurement for each fabric length.

34. A method according to claim 20, wherein the colour outputs are analysed to determine the range of colours represented by the colour outputs for a fabric length.

35. A method according to claim 34, wherein the method determines if the range of colours is greater than a permitted maximum range.

36. A method according to claim 20, wherein the method compares colour outputs to identify matching areas of the fabric by reference to the position outputs.

37. A method according to claim 20, wherein the method analyses the colour outputs in order to calculate Delta E values.

38. Software which, when installed on a computer system, is operable to perform the whole or any part of the method of claim 20.

39. A computer readable medium having machine-readable instructions recorded thereon and representing software according to claim 38.

40. (canceled)

41. A batch of fabric panels cut from fabric lengths, the fabric panels being matched in accordance with colour outputs and position outputs obtained by means of the apparatus of claim 1.

42. A batch of fabric panels cut from fabric lengths, the fabric panels being matched in accordance with colour outputs and position outputs obtained in accordance with the method of claim 20.

43-44. (canceled)
